(19) United States
(12) Patent Application Publication
(10) Pub. No.: US 2007/0160080 A1
(43) Pub. Date: Jul. 12, 2007

(54) Computer resource allocation system and method thereof

(76) Inventors: Kiminori Sugauchi, Yokohama (JP); Emiko Kobayashi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/431,829

(22) Filed: May 11, 2006

(30) Foreign Application Priority Data
Jan. 12, 2006 (JP) 2006-004560

(51) Int. Cl. H04J 3/22; H04L 12/56

(52) U.S. Cl. 370/468; 370/395.2

(57) ABSTRACT

To effectively allocate a computer resource in an environment where the number of computer resources is smaller than the number of users. It is provided with a section for monitoring the utilization state of the computer resources and a section for registering the condition of the possibility of release depending on the user attributes and the computer resource attributes, where when a new allocation request comes up in the state where all the computer resources are allocated, the unused computer resource is identified, released and allocated depending on the utilization state and the condition of the possibility of release.

### CLAIM OF PRIORITY

The present application claims priority from Japanese Application P2006-004560 filed on Jan. 12, 2006, the content of which is hereby incorporated by reference into this application.

### BACKGROUND OF THE INVENTION

1. Field of the Invention

The present invention relates to management of a computer system for accessing a remote computer via a network, such as a remote desktop.

2. Description of the Related Art

There currently exists a technology that blades and consolidates the data and applications stored in a disk of a personal computer (PC) that each individual user uses to allocate to the user. The bladed PC is called as the blade PC. The user's own PC holds only the minimum application for accessing the blade PC to display a result that is processed in the blade PC side. The user accesses the blade PC from the own PC to carry out different processes.

Further, there exists a system configuration that separates the data area and the startup disk area from the blade PC to store in a storage device (see, for example, Non-Patent Document 1, Nikkei Communications, Feb. 1, 2005, pages 72 to 73). In the case of the system that separates the data area and the startup disk area to store in the storage device, there is no need to allocate each blade PC to a fixed user, so that it is possible to allocate an unoccupied blade PC to the accessing user. In other words, the blade PC can be shared. By sharing the blade PC, the number of blade PCs can be reduced smaller than the number of current users, which makes it possible to reduce the physical resources and to increase the resource utilization rate.

In an environment where the number of blade PCs is smaller than the number of all users who are allowed to use the blade PC, when more users than the number of blade PCs try to use at the same time, some users can not use the blade PC. In such a case, it requires a process of identifying the user who is connecting but not actually using the blade PC, separating the connection of the user, and allocating a new user who wants to use.

For example, there is a technology, in a system which is a server client system with a limited number of logins to the server, that forcibly opens the logging in client in order to allow the accessing user to log in, when the number of logins reaches to the maximum number (see, for example, Patent Document 1, Japanese Patent Publication Laid-Open No. HEI 10-198622).

The technology described in Patent Document 1 allows the client having no access for a predetermined period of time or more to logout, and thereby accepts a new login request. However, in the system where most of the user's PC environment is held in the blade PC side as described above, the user's application itself is running on the blade PC. Thus, although the user is not accessing the blade PC, the application the user has specified may be running in the blade PC side.

In such a system, it is impossible to determine the user that can be released from the connection, only based on the access state to the blade PC. In other words, in such an environment where the number of blade PCs which are the resources is limited, it is impossible to appropriately extract unused blade PCs if there are more accesses from the users than the number of blade PCs.

### SUMMARY OF THE INVENTION

The present invention is made in light of the above described circumstances, and the object is to provide a technology that can effectively use the limited resources, when the number of blade PC resources that the system administrator provides as client blade system is smaller than the number of users.

In order to solve the above problem, in one aspect, the invention includes a section for collecting usage states of the resources and a section for holding the conditions that determine the utilization state from the collected usage states so that the management system for managing the resources can determine the unused resource.

More specifically, the aspect of the invention is directed to a computer resource allocation system for allocating one computer resource of a plurality of computer resources to a user requesting the use. The system includes: an allocation section, when a user request the use, for allocating a computer resource not allocated to any user, to the user; and an allocation release section, when a use request comes from a new user while all the computer resources are allocated, for defining the computer resource to be released from the allocation in accordance with the release condition determining the state that the user is not using, thereby to release the allocation. The allocation section, when the use request comes from the new user while all the computer resources are allocated, allocates the computer resource that the allocation release section released, to the user requesting the use.

The aspect of the present invention makes it possible to effectively use the limited resources, when the number of blade PC resources that the system administrator provides as client blade system is smaller than the number of users.

### BRIEF DESCRIPTION OF THE DRAWINGS

Embodiments of the present invention will be described in detail based on the following figures, wherein:

FIG. 1 is a system configuration view of a first embodiment;

FIGS. 2A and 2B are views showing examples of databases stored in a memory section of the first embodiment;

FIG. 3 is a view showing an example of an interrupt control policy file of the first embodiment;

FIG. 4 is a view showing an example of an internal table of the first embodiment;

FIG. 5 is a view showing an example of an interrupt information table of the first embodiment;

FIG. 6 is a view showing a screen example of a notification screen of the first embodiment;

FIG. 7 is a view showing a screen example of a confirmation screen of the first embodiment;

FIG. 8 is a view for illustrating the overview of the information transaction among devices of the first embodiment;

FIG. 9 is a flowchart of a process of a managed allocation control program of the first embodiment;

FIG. 10 is a flowchart of a use request process upon reception of an allocation request of the first embodiment;

FIG. 11 is a flowchart of a reallocation process of the first embodiment;

FIG. 12 is a flowchart of a process upon reception of a release request of the first embodiment;

FIG. 13 is a system configuration view of a second embodiment;

FIG. 14 is a view showing an example of an interrupt information table of the second embodiment; and

FIG. 15 is a system configuration view of a third embodiment.

### DESCRIPTION OF THE PREFERRED EMBODIMENTS

### First Embodiment

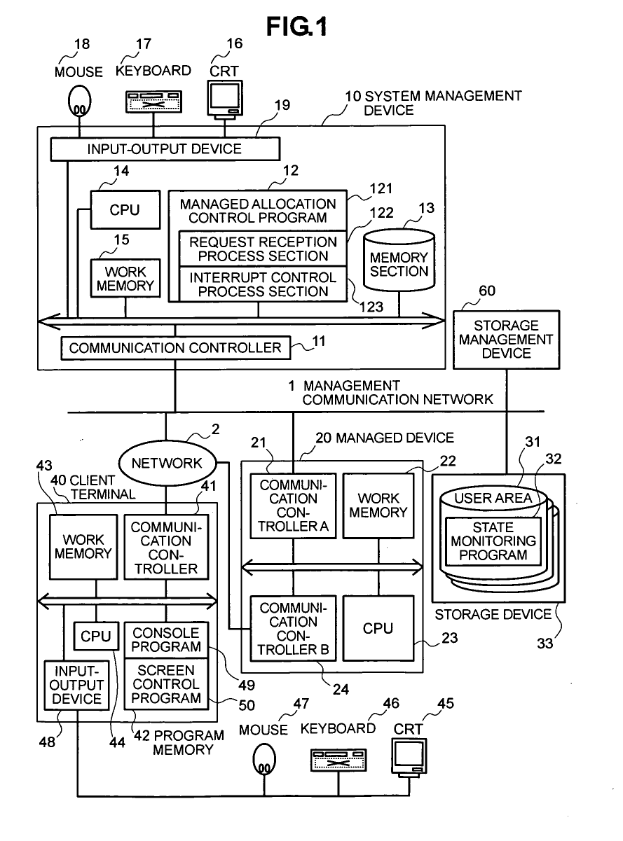

Hereinafter, embodiments applying the present invention will be described using the accompanying drawings. First of all, a first embodiment will be described using FIGS. 1 to 12.

FIG. 1 is a system configuration view of a blade PC system remotely using a blade PC of the embodiment. This system is made up of: a managed device 20 which is a blade PC including a configuration equivalent to a PC a user uses; a storage device 30 for holding disk information the managed device 20 uses; a client terminal 40 to be an interface for the user to remotely access the managed device 20; a storage management device 60 for managing the storage device 30; and a system management device 10 for managing the entire system. The system management device 10, the managed device 20, the storage device 30 and the storage management device 60 are connected by a management communication network 1. The client terminal 40 is connected with the management communication network 1 via a network 2. Incidentally, the number of managed devices 20 within the system is smaller than the number of users who are allowed to use them.

The managed device 20 includes: a communication controller A21 for communicating with the system management device 10 in order to access a user area 31 allocated to each user within the storage device 30; a work memory 24 for executing applications; a central processing unit (CPU) 23 for executing processes; and a communication controller B22 for receiving a command from the client terminal 40 and sending screen information. In the embodiment, there are separately provided the communication controller A21 for communicating with the system management device 10 and the storage device 30, and the communication controller B22 for communicating with the client terminal 40, respectively. However, the two communication controllers may be configured as a single communication controller.

The user areas 31 are reserved for individual users within the storage device 30. Each of the user areas 31 functions as a hard disk of the managed device 20, where a state monitoring program 32, data and applications of the user, an operating system and the like are separately stored. The state monitoring program 32 is executed in the managed device 20 to monitor the state of the relevant managed device 20 and notify the system management device 10. The details will be described below.

The client terminal 40 includes: a communication controller 41 for communicating with the managed device 20 and the system management device 10 via the network 2; a program memory 42 for storing program information; a work memory 43 for executing the programs; a central processing unit (CPU) 44 for executing the programs; a display (CRT) 45 which is an output device for displaying image information received from the managed device 20; a keyboard 46 and mouse 47 which are the input devices for accepting inputs of data for processing the user data; and an input-output controller 48 for controlling the above described input and output devices.

The program memory 42 on the client terminal 40 includes a console program 49 for exchanging information with the system management device 10, and a screen control program 50 for sending the input data accepted via the input devices 46, 47 to the managed device 20 and receiving the screen information sent from the managed device 20.

The system management device 10 includes: the client terminal 40 the user is using; the storage device 60; a communication controller 11 for communicating with the managed device 20; a work memory 15 used as a calculation area for the program process and a storage area for the results; a memory section 13 for storing databases such as the user information and the configuration information of the managed device 20, as well as data required for different processes; a program memory 12 for storing programs pertaining to management; a central processing unit (CPU) 14 for executing the programs stored in the program memory 12 and controlling the accesses in the program memory 12 and memory section 13; a display (CRT) 16 which is an output device for displaying management information about usage state of the managed device 20 and the like; a keyboard 17 and mouse 18 which are the input devices for accepting the inputs of information from the system administrator; and an input-output controller 19 for controlling the above described input and output devices.

The program memory 12 holds a managed allocation control program 121 for allocating the managed device 20 to the accessing user. The CPU 14 realizes a request reception process section 122 for accepting a request from the user via the client terminal 40 to carry out a process by executing the managed allocation control program 121, and when all the managed devices 20 are allocated to the users, an interrupt control section 123 for selecting the managed device 20 that can be released from the allocation, among the managed devices 20.

The request that the request reception process section 122 receives from the user via the client terminal 40, includes the allocation request for requesting to allocate and start up the managed device 20, and the release request for requesting to stop the allocated managed device 20 and release the allocation. Upon reception of the allocation request, the request reception process section 122 allocates the managed device 20 to the user having sent the allocation request and starts up the allocated managed device 20. Upon reception of the release request, the request reception process section 122 stops the managed device 20 that is allocated to the user (client terminal 40) having sent the release request, and releases the allocation.

The storage management device 60 creates within the storage device 30 the user areas 31 to be allocated to each of the users, and sets the created user areas 31 so that the managed devices 20 can use them.

Next, the information stored in the memory section 13 will be described. The memory section 13 includes two types of databases: a user information table 210 storing user information which is the information about the users using the system; and a managed device table 220 storing information about the managed devices 20. Further stored in the memory section 13 are: an interrupt control policy file 500 previously set by the system administrator or other person in charge; an internal table 800 where data obtained by the state monitoring program 32 is stored; an interrupt information table 1000 created when the reallocation process is carried out by the interrupt control process section 123; a notification screen 900 data used for the inquiry to the user in the reallocation process; and a confirmation screen 1100 data. The details will be each described below.

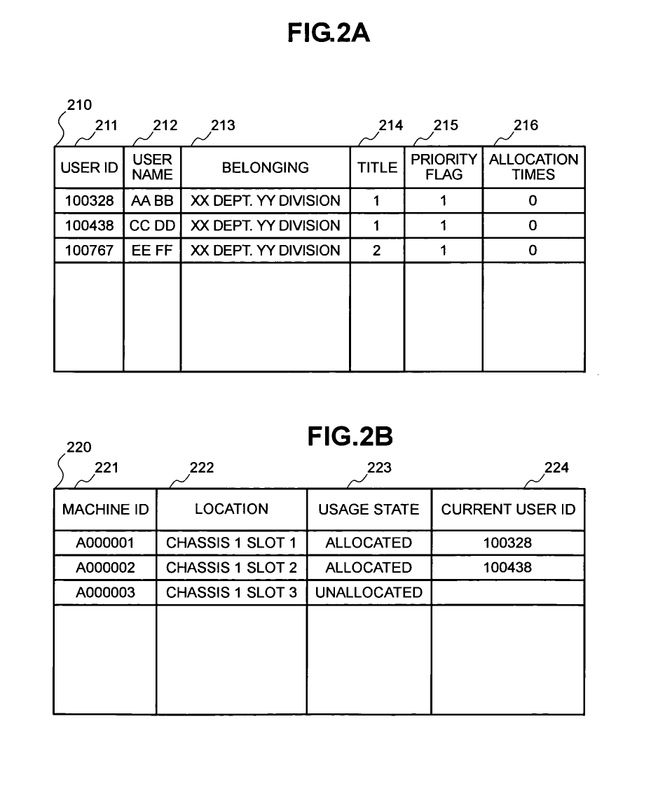

FIGS. 2A and 2B respectively show parts of the databases stored in the memory section 13. FIG. 2A shows the user information table 210, and FIG. 2B shows the managed device table 220.

In the system of the embodiment, relating to all the users allowed the use of the managed device 20, a user ID 211, a user name 212, a belonging 213, a title 214, a priority flag 215, and a number of allocation times 216 are registered in the user information table 210 for each user.

The user ID 211 is the identification information previously allocated to each user for uniquely identifying the user, where the number is used in the embodiment. The user name 212 is the actual name of the user. The belonging 213 is the department and division the user belongs to in the company. The title 214 is the title of the user. In the embodiment, data indicating each title by a number is registered as the title 214. The number indicating the title is set so that the value increases as the level of the title rises, such as 1 for “general staff”, 2 for “assistant manager”, and 3 for “manager”. The priority flag 215 is the information to identify the interruptible user. In the embodiment, 1 is registered as the interruptible user, and 0 is registered as the non-interruptible user. Stored in the number of allocation times 216 is the number of allocation times having been executed within a certain period of time in the past. This is registered only for the user with 1 registered in the priority flag 215.

Herein, in the case of the user registered as interruptible, although all the managed devices 20 are allocated to the users, as long as any releasable user exists, it is possible that the managed device 20 allocated to the relevant user is released, and that the released managed device 20 is allocated to start up the PC environment on the allocated managed device 20. On the other hand, in the case of the user registered as non-interruptible, it is always impossible to startup the user's own PC environment when all the managed devices 20 are allocated to the users.

In the managed device table 220, a machine ID 221, a location 222, a utilization state 223, and a current user ID 224 are stored for each of the managed devices 20.

The machine ID 221 is the information for uniquely identifying each of the managed devices 20. The location 222 is the information for identifying the location where each of the managed devices 20 is located. For example, in the case of the blade system where the managed device 20 is made up of the blade, the information indicating that the blade is located in which slot of which chassis is registered. The utilization state 223 is the information indicating the latest utilization state of the managed device 20. In the utilization state 223, “allocated” or “unallocated” is registered. It indicates that the managed device 20 with “allocated” registered is already allocated to the user, and that the managed device 20 with “unallocated” registered is not allocated to any user. The current user ID 224 is the user ID of the user allocated to the relevant managed device 20. The user ID registered in the current user ID 224 corresponds to any of the values in the user ID 211 of the user information table 210. Only the user ID with “allocated” for the utilization state 223 is registered in the current user ID 224. The current user ID 224 registered to the managed device with the utilization state 223 as “unallocated” is not significant.

Next, the interrupt control policy file 500 will be described. The interrupt control policy file 500 is written about the rule for allocating the managed device 20, when the allocation request comes from the user via the client terminal 40. Herein is written the condition for extracting the managed device 20 to be the target of reallocation process, when all the managed devices 20 are allocated to the users. Incidentally, the reallocation process is an interruption process, when the allocation request is made while all the managed devices 20 are allocated to the users, for releasing the allocation of the managed device 20 that is already allocated, and allocating the relevant managed device 20 to the user having made the allocation request.

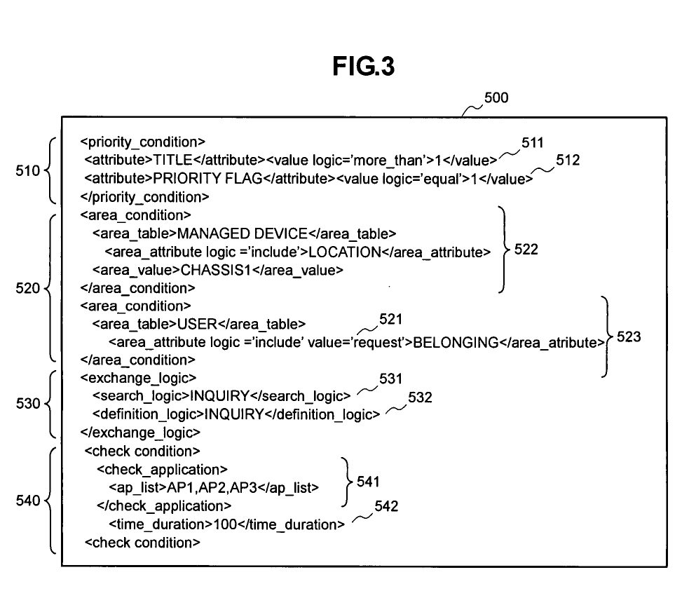

FIG. 3 shows an example of the interrupt control policy file 500 of the embodiment.

The interrupt control policy file 500 includes: a priority condition 510 for limiting the user to which the reallocation process can be executed, of the users having made the allocation request; an interrupt target condition 520 for limiting the range of the managed devices 20 to which the reallocation process is executed, of the managed devices 20; an execution condition 530 indicating the condition for executing the reallocation process; and a state monitoring condition 540 for providing the condition that determines whether the managed device 20 is used.

The condition specified in the priority condition 510 is for the user to which the reallocation process is executed. In other words, the reallocation process is executed to the user satisfying the condition specified in the priority condition 510. The condition is written using the information registered in the user information table 210.

More specifically, the priority condition 510 is written between <priority_condition> and </priority_condition>. The key (item name) in the user information table 210 is written between <attribute> and </attribute>. The value the key must satisfy is written between <value logic=‘more_than’> and </value>. Further, the statement following “logic” in <value logic=‘more_than’> indicates the comparison method of the statement as the value and the value of the key corresponding to the user making the allocation request. The case of ‘more_than’ indicates an equal or greater value, ‘equal’ indicates the same value, and ‘less_than’ indicates an equal or smaller value. In the example of FIG. 3, the condition 511 indicates that the reallocation process is executed if the “title” of the user having made the allocation request is 1 or more. The condition 512 indicates that the real location process is executed if the “priority flag” of the user having made the allocation request is 1.

Incidentally, a plurality of priority conditions 510 can be specified. The conditions written in the range encompassed by <priority_condition> and </priority_condition> are AND conditions. In other words, the reallocation process is executed if all the conditions written in the range are satisfied. When a plurality of conditions each encompassed by <priority_condition> and </priority_condition> are written, the conditions are OR conditions respectively. In other words, the reallocation process is executed if any of the conditions is satisfied. The example of FIG. 3 shows that the reallocation process is executed if the “title” is 1 or more and the “priority flag” is 1.

The condition specified in the interrupt target condition 520 is for identifying the target to which the reallocation process is executed. The interrupt target condition 520 is written between <area_condition> and </area_condition>. The interrupt target condition 520 includes the condition for specifying the target table written between <area_table> and </area_table>, the condition for specifying the item of the target table written between <area_attribute> and </area_attribute>, and the condition for specifying the value to be satisfied, written between <area_value> and </area—value>.

Incidentally, the comparison method is written, as logic, within the <area_attribute> tag. The information between <area_condition> and </area_condition> is similar to the information between <priority_condition> and </priority_condition>. When a plurality of conditions exist in the range of <area_condition></area_condition>, the condition is that satisfies all the conditions. When a plurality of <area_condition></area_condition> conditions exists, the target is that satisfies any of the conditions respectively. In other words, the AND conditions are written between <area_condition> and </area_condition>. The conditions each written being encompassed by <area_condition> and </area_condition> are the OR conditions, respectively.

In the example of FIG. 3, the condition 522 specifies the managed device with “chassis 1” registered in the location 222 of the managed device table 220, as the target to which the reallocation process is executed. Herein, “logic” in <area_attribute logic=‘include’> indicates the comparison method of the statement set as the value and the attribute value for searching for the management information in the target range, where ‘include’ is that determines whether the value specified between <area_value> and </area_value> is included, which will be described below.

Further, the condition 523 specifies, as the target to which the reallocation process is executed, the managed device 20 to which the user makes the allocation request, under the condition that the relevant user includes the value registered as the belonging 213 of the user having made the allocation request, for the belonging 213 of the user table 210. Herein, “value” exists in <area_attribute logic=‘include’value=‘request’>. In the case where the value is “request”, the condition for comparison is determined based on the attribute of the user having made the allocation request. In other words, when the user having the user information including the value of the belonging 213 attribute of the allocation requesting user for the belonging 213 of the user information table 210, starts up the managed device, this managed device 20 is the target of the reallocation process. In the example of FIG. 3, the managed device 20 that satisfies either of the two conditions 522 and 523 is the target of the reallocation process.

The execution condition 530 is written between <exchange_logic> and </exchange_logic>. The condition for starting the reallocation (start condition) and the condition for defining the managed device 20 to be the target in the reallocation process (definition condition) are set in the execution condition 530.

The start condition is written between <search_logic> and </search_logic>. The start condition includes, when the allocation request exists and the reallocation is required, a method of making an inquiry to the user having made the allocation request before the start of the process, and a method of starting the process without carrying out the inquiry. For the former case, the value indicating “inquiry” is written between <search_logic> and </search_logic>, and the value indicating “automatic” is written for the latter case. In the example of FIG. 3, the condition 531 indicates the case of carrying out the inquiry.

The definition condition is written between <definition_logic> and </definition_logic>. The definition condition includes a method of defining the user and/or managed device 20 to be the target of the reallocation process while inquiring about the intention of the current user in the reallocation process, and a method of carrying out the reallocation process without inquiring the user. There are written “inquiry” for the former case and “automatic” for the latter case. The condition 532 of FIG. 3 indicates that the method of making the inquiry is specified.

The state monitoring condition 540 is written between <check_condition> and </check_condition>. The target of the state monitoring includes the utilization states of specific applications and non-access time to the managed device 20.

The types of applications, which are the monitoring targets for determining the utilization state of the user, are written between <check_application> and </check_application>. When the application written between <ap_list> and </ap_list> is running, which is recorded in the internal table 800 described below. In the condition 541 of FIG. 3, when any of the three applications AP1, AP2, AP3 is running on the managed device 20, the utilization state of each of the applications is recorded in the internal table 800.

The time based on which the managed device 20 is determined as unused is set in minutes between <time_duration> and </time_duration>. The time used for the determination is the period of time in which there is no access from the user allocated to the relevant managed device 20, to the relevant managed device 20 via the client terminal 40. In the condition 542 of FIG. 3, the relevant managed device 20 is determined as unused, when the non-access state continues more than 100 minutes.

The description has been made on the interrupt control policy file 500.

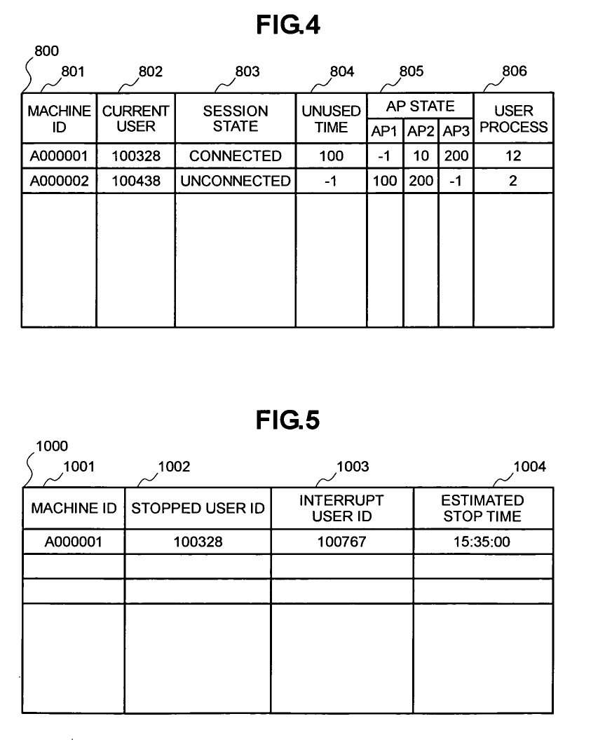

Next, the internal table 800 will be described. Stored in the internal table 800 are the states on each of the managed devices, which are collected by the state monitoring program 32 running on the managed devices 20 and are sent to the system management device 10. FIG. 4 is a view for illustrating the internal table 800.

As shown in the figure, in the internal table 800, a machine ID 801 of the relevant managed device, a current user 802, a session state 803, an unused time 804, an AP state 805 which is the utilization states of the specific applications, and a user process 806 are registered for each of the managed devices 20.

As the current user 802, the user ID of the user allocated to the relevant managed device 20 is registered. The connection state between the client terminal 40 and the managed device 20 is obtained by the state monitoring program 32, and “connected” or “unconnected” is registered depending on the obtained state as the session state 803. The unused time 804 is relating to the session state 803 registered as “connected”, where the time from the last key-in is counted by the state monitoring program 32, and is registered. Incidentally, the unused time 804 is not significant for the managed device with the session state 803 “unconnected”, thereby −1 is registered.

Next, the utilization states of the monitored applications specified in the state monitoring condition 540 of the interrupt control policy file 500 are registered as the AP state 805, respectively. The utilization state registered herein represents the period of time in which the application is not using the CPU 14 of the managed device 20, when the relevant application starts up. This information is also counted by the state monitoring program 32. Incidentally, when the application does not start up, −1 is registered. The information about the application startup/non-startup is also obtained by the state monitoring program 32. In the user process 806, the number of processes that the user started up from the client 40 is registered in the managed device 20.

Next, the interrupt information table 1000 will be described. In the interrupt information table 1000, the information about the user having made the allocation request and the user released from the allocation to the managed device 20, is recorded by the interrupt control process section 123, when carrying out the reallocation process.

FIG. 5 is a view showing an example of the interrupt information table 1000. As shown in the figure, in the interrupt information table 1000, a machine ID 1001 for identifying the relevant managed device 20, a stopped user ID 1002 which is the identifier of the user released from the allocation to the managed device 20, an interrupt user ID 1003 which is the identifier of the user receiving the reallocation, and an estimated stop time 1004 which is the estimated period of time in when the unallocated user is released from the allocation are registered for each of the managed devices 20. The time registered in the estimated stop time 1004 is the estimated usage time input from the allocation request source user through the notification screen 900 which is described below. Hereinafter, the user released from the allocation by the reallocation process is called as the stopped user.

The request reception process section 122 uses the interrupt information table 1000 for allocating the released managed device 20 to the stopped user, upon reception of the release request from the user. It is assumed that the data in this table are arranged in the order of time in which the managed devices 20 are interrupted, and when the stopped user is released from the stop, namely, when the allocation is returned, the relevant data is deleted.

Next, the notification screen 900 will be described. The notification screen 900 data is sent to the client terminal 40 of the allocation request source user in the start of the reallocation process, when “inquiry” is written in the start condition of the execution condition 530 of the interrupt control policy file 500. The console program 49 of the client terminal 40 receives the notification screen 900 data and notifies the screen control program 50. The screen control program 50 processes the notification screen 900 data and causes the display device 45 to display the processed data. FIG. 6 shows a screen example displayed in the display device 45.

As shown in the figure, the notification screen displayed by the notification screen 900 data includes: a content display section 904 for displaying the content of the inquiry; a use request button 902 for accepting the intention of wanting startup; an end button 903 for accepting the intention of not wanting startup; and a usage time input field 901 for accepting the input of the usage time for the intention of wanting startup. The usage time is the estimated period of time in which the user having sent the allocation request will use the managed device 20. When there exist the plurality of managed deices 20 to be the targets of the reallocation process as described below, the usage time is used for extracting one from the plurality of managed devices 20.

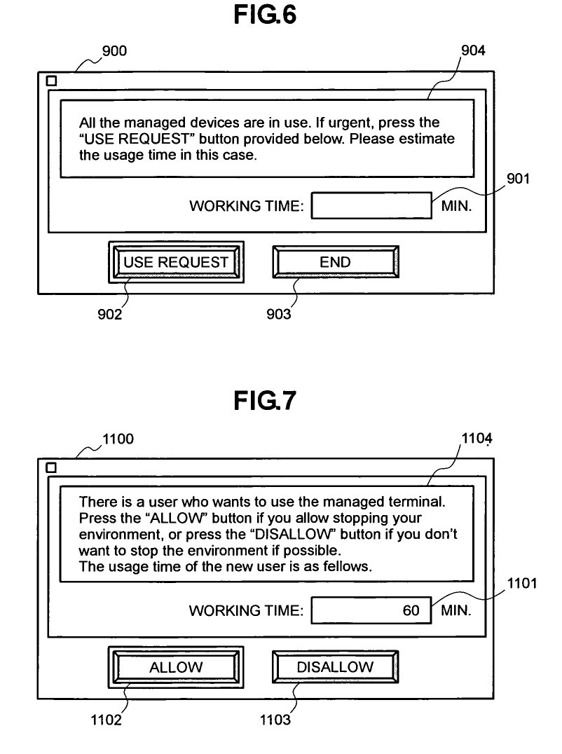

Next, the confirmation screen 1100 will be described. The confirmation screen 1100 data is sent to the client terminal 40 of the user of the candidate managed device 20 to be stopped, when “inquiry” is written in the definition condition of the execution condition 530 of the interrupt control policy file 500. FIG. 7 shows a screen example displayed in the display device 45 of the client terminal 40.

As shown in the figure, the confirmation screen 1100 includes: a content display section 1104 for displaying the content; an allow button 1102 for accepting the intention of allowing stop; a disallow button 1103 for accepting the intention of not allowing stop; and a usage time display field 1101 for displaying the estimated usage time of the user to be reallocated. Displayed in the usage time display filed 1101 is the time that the allocation request source user has input to the usage time input filed 901 in the inquiry screen 900.

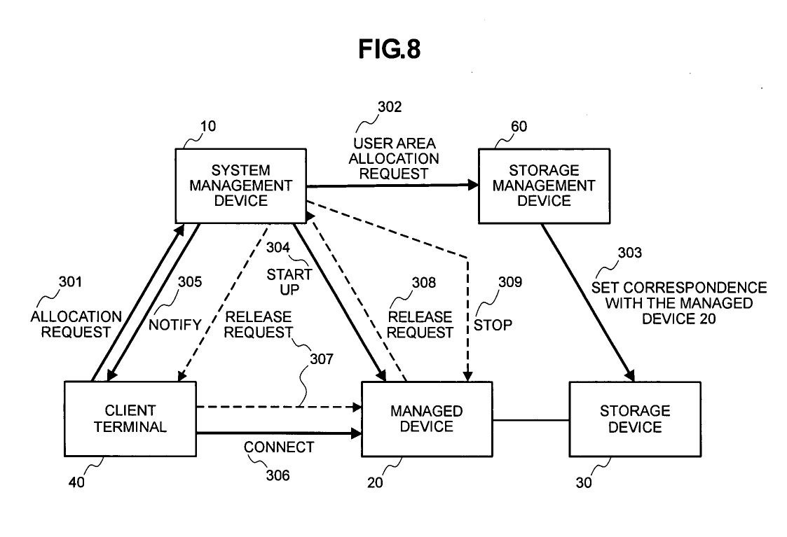

Next, the overview of the information transaction among the devices in the embodiment will be described. FIG. 8 is a view for illustrating the overview of the information transaction among the above described devices.

The user, when wanting to use the PC environment on the managed device 20, requests startup to the system management device 10, together with the information for identifying the user, using the console program 49 of the client terminal 40. In other words, the client terminal 40 receives the instruction from the user and sends the allocation request for requesting the allocation and startup of the managed device 20 to the system management device 10 by the console program 49 (Step 301).

Upon reception of the allocation request from the user via the client terminal 40, the system management device 10 defines the managed device 20 that can be allocated to the user, and notifies the storage management device 60 about the definition, together with the information for identifying the user (Step 302). The storage management device 60 allocates the user area 31 allocated to the user, to the notified managed device 20 (Step 303).

Subsequently, the system management device 10 starts up the allocated managed device 20 (Step 304), and notifies the console program 49 on the client terminal 40 having sent the allocation request about the result (Step 305).

The console program 49 notifies the screen control program 50 about the information on the managed device 20 allocated to the user. Then, the screen control program 50 connects to the allocated managed device 20 (Step 306), receives the screen information on the relevant managed device 20, and displays the result on the CRT 45. The user logs in the managed device 20, using the mouse 47 and the keyboard 46 while seeing the displayed screen information, and starts up the application on the managed device 20 to process the user data.

Having completed the desired process, the user sends a release request to stop the used managed device 20, and completes the process. There are two types of methods to stop the managed device 20 in the embodiment: a method of sending the release request for directly requesting stop to the managed device 20 from the client terminal 40; and a method of making the release request to the system management device 10 via the console program 49 on the client terminal 40 (Step 307).

When the release request is directly sent from the client terminal 40 to the managed device 20, the system management device 10 receives the release request from the state monitoring program 32 running on the managed device 20 (Step 308), and updates the internal data of the user information table 210, managed device table 220 and the like. When receiving the release request from the console program 49 of the client terminal 40, the system management device 10 carries out the process of stopping the relevant managed device 20 (Step 309).

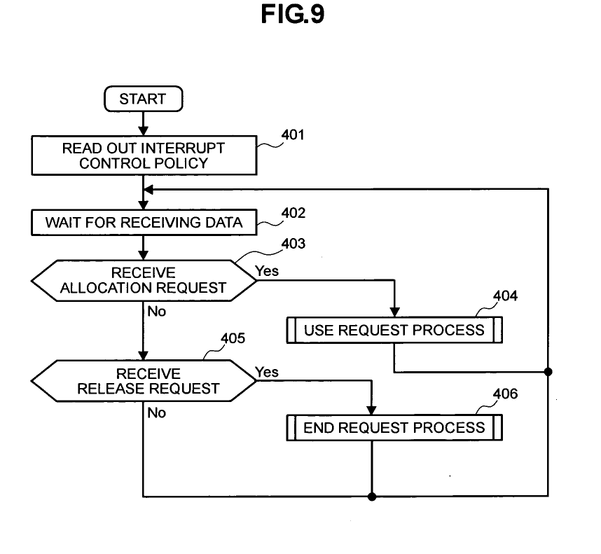

Next, the general operation of the managed allocation control program 121 of the system management device 10 will be described. FIG. 9 is a flowchart showing the general process of the managed allocation control program 121 of the embodiment.

Upon startup of the system management device 10, the managed allocation control program 121 executes the request reception process section 122.

The request reception process section 122 first reads out the allocation control policy file 500 (Step 401).

The request reception process section 122 analyzes the read out allocation control policy file 500 and holds the analyzed results in the work memory 15. Subsequently, the section is in the state of waiting for receiving data from the client terminal 40 and the managed device 20 (Step 402).

Upon reception of the data, the request reception process section 122 analyzes the content of the received data (Steps 403, 405). When the received data is the allocation request from the client terminal 40 (Step 403), the section executes the use request process described below (Step 404). When the received data is the release request from the client terminal 40 or the managed device 20 (Step 405), the section executes the end request process described below (Step 406).

When the content of the received data corresponds to neither of the above two, when the use request process is completed, or when the end request process is completed, the request reception process section 122 returns to Step 402 to be in the reception waiting state.

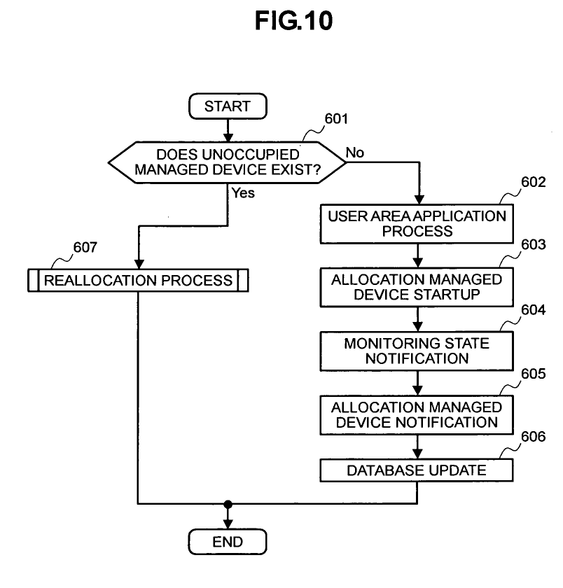

Next, the details of the use request process of Step 404 will be described. FIG. 10 is a flowchart of the use request process.

The request reception process section 122 receives an instruction to start the use request process, and determines whether any allocatable managed devices 20 exist (Step 601). In other words, the section determines the existence or non-existence of the unused managed device 20 (unoccupied managed device 20). This is determined by the utilization state 223 of the managed device table 220. When unused managed devices 20 exist, the section allocates one managed device 20 extracted from the unused ones to the allocation request source user.

More specifically, the request reception process section 122 first requests the storage management device 30 to allocate the user area 31 of the user having sent the allocation request to the extracted managed device 20 (Step 602). Having completed the process of Step 602, the section starts up the managed device 20 (Step 603). Then, the section notifies the state monitoring program 32 to be executed on the allocated managed device 20 about the condition-monitored applications specified within the state monitoring condition 540 of the interrupt control policy file 500, as the monitored application list (Step 604).

Having completed the above process, the request reception process section 122 notifies the source client terminal 40 of the allocation request about the information to identify the allocated managed device 20 (Step 605). Then, the section updates the usage condition 223 and current user ID 224 of the managed device information table 220 to the information after allocation (Step 606).

Incidentally, the managed device 20, upon startup, with the use of the state monitoring program 32, always monitors the existence or non-existence of the startup of the applications on the specified monitored application list, the existence or non-existence of the logon from the user, and the existence or non-existence of the keyboard and mouse operation from the user, and sends as the condition information to the system management device 10.

On the other hand, when no unused managed device 20 exists in Step 601, the request reception procession section 122 causes the interrupt control process section 123 to carry out the reallocation process (Step 607).

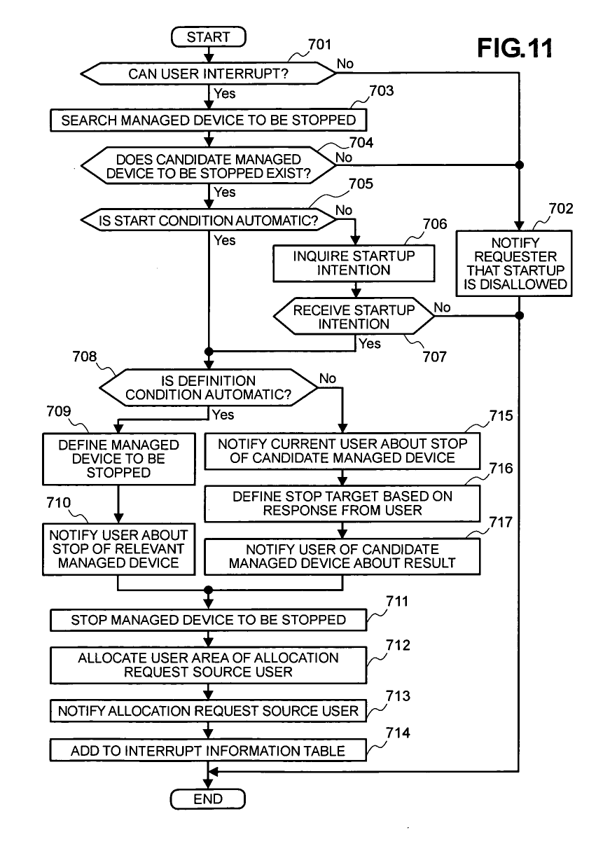

The details of the reallocation process will be described below. FIG. 11 is a flowchart of the reallocation process of the embodiment. Basically, the interrupt control process section 123 sequentially determines whether the allocation request satisfies the conditions written in the interrupt control policy file 500 to proceed with the process.

The interrupt control process section 123 determines whether the user having sent the allocation request is the user allowed to interrupt (Step 701). More specifically, the section determines whether the information registered in the user information table 210 being associated with the user ID of the allocation request source user, which is added to the allocation request, satisfies the priority condition 510 of the interrupt control policy file 500. When the information satisfies the priority condition 510, the section determines as the interruptible user, namely, the real locatable user. In the case of the interrupt control policy file 500 as shown in FIG. 3, when the information of the title 214 and priority flag 215 of the allocation request source user satisfies the priority condition 510, the section determines as the interruptible user.

When the user is not interruptible, the interrupt control process section 123 notifies the client terminal that no usable environment exists, namely, that the startup can not be done due to the absence of the allocatable managed device 20 (Step 702), and ends the process.

When the user is interrutible, the interrupt control process section 123 next determines the existence or non-existence of the interruptible managed device 20 (Steps 703, 704). More specifically, the section first determines whether any manage devices 20 meeting the interrupt condition 520 of the interrupt control policy file 500 exist. Then, of those, the section determines whether the managed device 20 satisfying the conditions in the state monitoring condition 540 exists.

In the case of the interrupt control policy file 500 as shown in FIG. 3, the interrupt control process section 123 searches the managed devices 20 with the location 222 registered as “chassis 1” in the managed device table 220, or the managed devices 20 allocated to the user having the same belonging 213 as that of the allocation request source user by referring to the user information table 210 and the managed device table 220, as the candidate managed devices 20 to be stopped.

Then, the interrupt control process section 123 refers to the internal table 800 to extract the managed device 20 satisfying the given conditions, of the candidate managed devices 20 to be stopped which are searched as described above (Step 703).

In the embodiment, it is assumed, for example, that the managed device 20 satisfying any of the following conditions (selection conditions) is extracted as the candidate to be stopped. However, the conditions are not limited to those described below.
1) Managed device 20 with the session condition 803 as “unconnected” and the user process 806 as “0”.
2) Managed device 20 with the session condition 803 as “unconnected” and all the AP state 805 as “non-startup”.
3) Managed device 20 with the session condition 803 as “connected”, all the AP state 805 as “non-startup”, and the unused time 804 exceeding the time that is determined as unused and is specified in the state monitoring condition 540 of the interrupt control policy file 500.
4) Managed device 20 with the session condition 803 as “connected”, part of the AP state 805 as “startup”, but the unused time 804 exceeding the time that is determined as unused and is specified in the state monitoring condition 540 of the interrupt control policy file 500.

Having been able to extract the candidate managed devices 20 to be stopped in Step 703, the interrupt control process section 123 determines that the managed devices 20 meeting the interrupt condition 520 exist (Step 704).

When no candidate managed device 20 to be stopped exists in Step 704, the interrupt control process section 123 notifies the allocation request source user that the startup is impossible (Step 702), and ends the process.

When the candidate managed devices 20 to be stopped is found, the interrupt control process section 123 next determines the start condition of the execution condition 530 (Step 705). When the managed device 20 meeting the start condition exists, and in the case where “automatic” is set to execute the reallocation process, the interrupt control process section 123 just executes the reallocation process (Step 708).

On the other hand, when “inquiry” is set to the start condition of the execution condition 530, the interrupt control process section 123 inquires the user about whether to want startup (step 706).

When receiving the intention of not wanting startup from the user in response to the inquiry of Step 706, the interrupt control process section 123 ends the process. On the other hand, when receiving the intention of wanting startup from the user, the section executes the reallocation process (Step 708).

Upon execution of the reallocation process, the interrupt control process section 123 determines the definition condition of the execution condition 530 (step 708). When “automatic” is set to the definition condition, the section defines the managed device 20 to be stopped of the searched ones as the candidate managed devices 20 to be stopped (Step 709), and sends the stop notification to the user of the relevant managed device 20 (Step 710). When there exists the plurality of candidate managed devices 20 to be stopped, one of those is selected as the stopped managed device 20 based on the following method in the embodiment.

First, the interrupt control process section 123 gives a priority to each of the candidate managed devices 20 to be stopped satisfying the above described selection conditions 1 to 4, respectively. It is assumed that smaller the selection condition number is, the higher the selection priority is. When a plurality of candidates having the same priority exist for the case of the selection conditions 1 and 2, the interrupt control process section 123 refers to the user information table 210 to extract the managed device 20 that is allocated to the user with the smallest value for the allocation times 216. For the conditions 3 and 4, the section extracts the managed device 20 with the shortest time for the unused time 804. When the plurality of managed devices 20 correspond to those described above, the interrupt control process section 123 arbitrary selects one of them. It is to be noted that the selection criteria is not limited to this, and may be set and registered in the memory section 13 in advance.

The interrupt control process section 123 sends the stop notification to inform the client terminal 40 used by the user of the selected managed device 20 about the stop (Step 710). Then, the section stops the relevant managed device 20 (Step 711).

On the other hand, when “inquiry” is set to the definition condition in the determination of Step 708, the interrupt control process section 123 sends the confirmation screen 1100 data to all the client terminals 40 used by the users allocated to those searched and extracted as the candidate managed devices 20 to be stopped (Step 715).

Upon reception of a response from the user, the interrupt control process section 123 selects the managed device 20 to be stopped depending on the response (Step 716). When receiving the intension of “allow” from the plurality of managed devices 20, the section defines the managed device 20 to be stopped, in accordance with the selection rule that is provided by the system administrator or other person in charge and is registered in the memory section 13 in advance. The selection rule may be, for example, that selects the managed device 20 with the longest time for the unused time 804, or selects the managed device 20 allocated to the user not responding for a given period of time. Of course, the selection rule is not limited to this. When all the responses indicate “disallow”, namely, wanting continuous use, the interrupt control process section 123 selects based on the selection method in the case of the definition condition as “automatic” described above.

In Step 715, the interrupt control process section 123 sends the result to all the client terminals 40 to which the confirmation screen 1100 data has been sent (Step 717). Herein, the section sends the stop notification to the client terminal 40 of the user of the managed device 20 selected as the stop target in Step 716, while notifying the other client terminals 40 that they are not to be stopped. Then, the section stops the selected managed device 20 (Step 711).

Next, the interrupt control process section 123 allocates the selected managed device 20 to the user having sent the allocation request. In other words, the section allocates the user area 31 that is allocated to the user having sent the allocation request, to the managed device 20 stopped in Step 711, and notifies the state monitoring program 32 about the monitored application list (Step 712), and further notifies the allocation request source user about the completion of the allocation (Step 713). Then, the interrupt control process section 123 registers in the interrupt information table 1000 (Step 714), and ends the process.

Next, the description will be made on the process of the system management device 10 that receives a release request, when the user completes the use of the allocated managed device 20 and sends the release request which is the request to release the allocation.

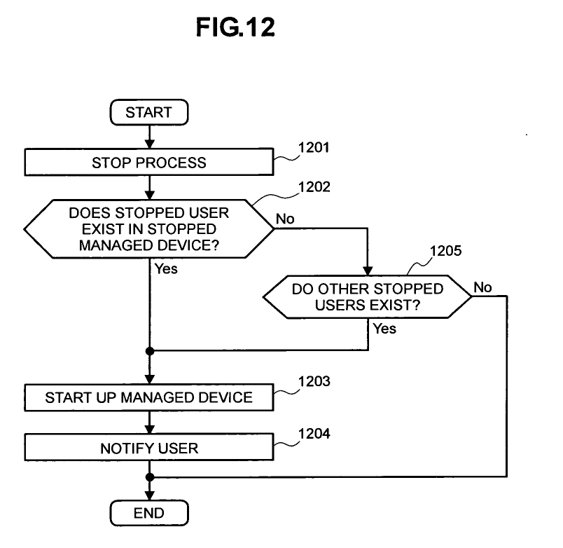

FIG. 12 is a flowchart of the process of the request reception process section 122 upon reception of the release request.

The request reception process section 122 receives the release request, and executes a power-off process (stop process) to the managed device 20 allocated to the source user (Step 1201). When the managed device 20 is in the power-off state, the request reception process section 122 determines the existence or non-existence of the interrupted user (Step 1202). More specifically, the section refers to the interrupt information table 1000, and determines that the interrupted user exists when stopped user ID is registered being associated with the machine ID of the managed device 20.

When determining that the interrupted user exists in Step 1202, the request reception process section 122 identifies the user registered in the stopped user ID as the return user. The return user is the user to which the managed device 20 released from the allocation is allocated. Then, the section starts up the managed device 20 that is made in the power-off state in Step 1201 (Step 1203). Herein, the section allocates the user area 31 allocated to the return user to the managed device 20 made in the power-off state, and starts up the relevant managed device 20. Further, the section deletes the data about the managed device 20 that is returned to the startup state, from the interrupt information table 1000.

On the other hand, when determining that no interrupted user exists in Step 1202, the request reception process section 122 refers to the interrupt information table 1000, and determines whether other users registered as the stopped user exist (Step 1205). When the other stopped users are registered, the section extracts the user having been stopped for the longest time (the user corresponding to the oldest data among the data registered in the interrupt information table 1000) of the relevant users, making the extracted user the return user. The section starts up the managed device 20 that is made in the power-off state in step 1201, and allocates the started up managed device to the return user (Step 1203). Then, the section deletes the data of the return user from the interrupt information table 1000.

After confirmation of the allocation, the request reception process section 122 notifies the return user that the managed device 20 has been reallocated (Step 1204), and ends the process.

When determining that no stopped user exists in Step 1205, the request reception process section 122 just ends the process.

As described above, with the embodiment, in an environment where the number of users allowed to use the managed device 20 is smaller than the number of managed devices 20, when a new user wanting to use the managed device occurs in the state where all the managed devise 20 are allocated to given users, it is possible to extract the user unlikely to actually use the managed device, of the users having been already allocated, and to release the allocation. In other words, the unused managed device 20 can be appropriately extracted. Thus, the embodiment makes it possible to effectively use the managed devices 20 which are the limited resources.

### Second Embodiment

Next, a second embodiment applying the invention will be described. In this embodiment, a system hibernation process is carried out for stopping the managed device 20 to be stopped in the reallocation process. In other words, the process is carried out to just evacuate the contents of the work memory 22 of the managed device 20 immediately before stopping.

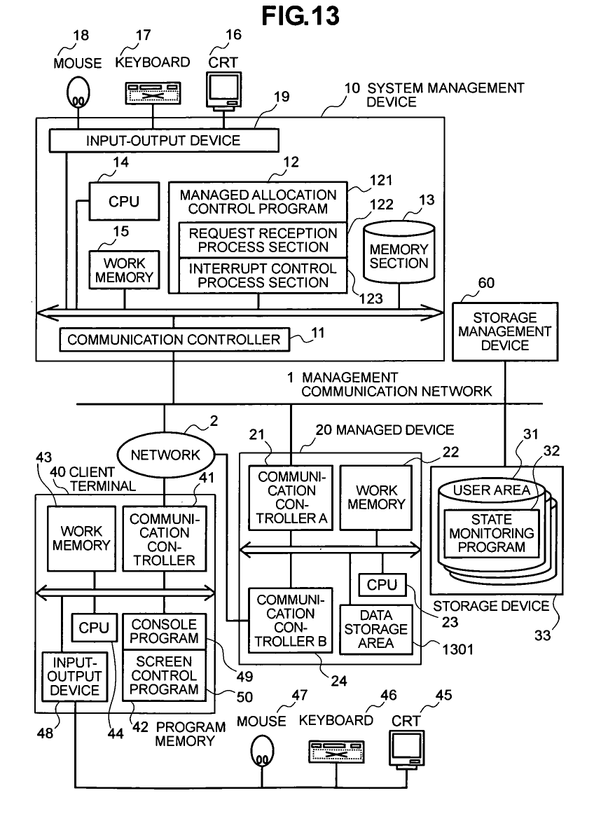

FIG. 13 is a system configuration view of the embodiment. The system configuration of the embodiment is essentially the same as the system configuration of the first embodiment. However, the managed devices 20 of the embodiment each include a data storage area 1301. The data storage area 1301 is an area where the data (contents of the work memory 22) are evacuated in the system hibernation.

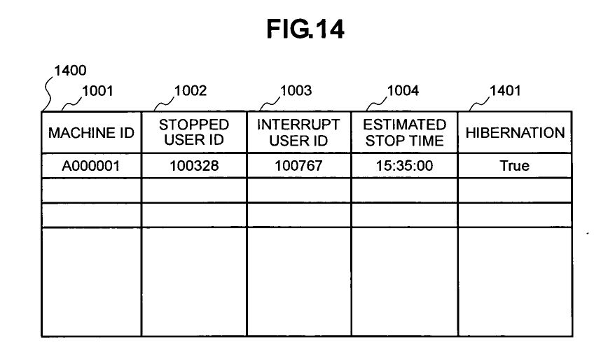

Further, FIG. 14 shows an example of an interrupt information table 1400 of the embodiment. In the interrupt information table 1400 of this embodiment, similarly to the interrupt information table 1000 of the first embodiment, the machine ID 1001 for identifying the relevant managed device 20, the stopped user ID 1002 which is the identifier of the user released from the allocation to the managed device 20, the interrupt user ID 1003 which is the identifier of the user receiving reallocation, and the estimated stop time 1004 which is the estimated period of time in which the unallocated user is released from the allocation are registered for each of the managed devices 20. Further registered in the interrupt information table 1400 of the embodiment is a hibernation 1401 indicating whether the managed device 20 stopped after carrying out the system hibernation. For the managed device stopped after carrying out the system hibernation, “True” is registered as the hibernation 1401, and if not, “False” is registered.

Next, relating to the reallocation process in the embodiment, only the processes different from the first embodiment will be described. The different parts from the first embodiment are the process of stopping the managed device to be stopped, and the registration process to the interrupt information table 1400. These processes correspond to Steps 711 and 714 in the flowchart of FIG. 11.

First, the different point in the stop process (Step 711) of the embodiment from the first embodiment will be described. In the embodiment, when the specific managed device 20 is selected as the stop target, the interrupt control process section 123 refers to the internal table 800, and confirms the utilization of the relevant managed device 20 used by the allocated user.

At this time, in the case where the session condition 803 is “unconnected” and the user process 806 is “0”, no work is substantially done on the managed device 20, so that the interrupt control process section 123 just stops the managed device 20.

In other cases, the interrupt control process section 123 causes the managed device 20 to carry out the system hibernation, before stopping the managed device 20. In the system hibernation, the managed device 20 evacuates the work environment at this point to the data storage area 1301. The interrupt control process section 123 stops the relevant managed device 20 after the system hibernation is completed.

Incidentally, in the embodiment, the interrupt control process section 123 may be configured to cause the managed device 20 to always carry out the system hibernation before stopping, without the step of referring to the internal table 800 to confirm the state of the relevant managed device 20.

Relating to the registration process to the interrupt information table 1000 (Step 714), the different point of the embodiment from the first embodiment is that the interrupt control process section 123 in the embodiment registers whether the managed device stopped after carrying out the system hibernation, to the hibernation 1401, in addition to the information that is registered in the first embodiment.

Next, relating to the process of the request reception process section 122 upon reception of the release request, the different points of the embodiment from the first embodiment will be described. The different points from the first embodiments are the process in the case where the stopped user is not registered being associated with the stopped managed device 20, and the process of retuning to the startup state of the return user. The processes correspond to the Steps 1205 and 1203 in FIG. 12.

In the process of Step 1205, the request reception process section 122 refers to the interrupt information table 1400 to determine whether the other user registered as the stopped user exists. At this time, the request reception process section 122 in the embodiment defines as existing, only when the stopped user registered as “False” in the hibernation 1401 exists. It is significant for the embodiment that the managed device 20 stopped after carrying out the system hibernation is returned to only the original user. Thus, when the stopped user exists and “False” is not registered in the hibernation 1401 of the relevant user, the request reception process section 122 ends the process as determining that no stopped user exists.

When it is defined as existing in Step 1202, the request reception process section 122 notifies the managed device 20 that it is the return from the system hibernation, when starting up the managed device 20. The managed device 20 receives the notification, and starts up in the operation state of the original user by expanding the data having been evacuated to the data storage area 1301 in the work memory 22. Incidentally, at this time, the request reception process section 122 may be configured to inquire the user about possibility of the return from the system hibernation, namely, the return in the original operation state. In this case, the section causes the managed device 20 to expand the data having been evacuated to the data storage area 1301 in the work memory 22 to start up, only when receiving the instruction to return in the original operation state from the user. If not, the section starts up the managed device 20 in the initial state.

On the other hand, in Step 1205, when it is determined that the other stopped user with “False” registered in the hibernation 1401 exists, the process proceeds to Step 1203. In this case, the request reception process section 122 starts up the managed device 20, similarly to the first embodiment, without notifying the managed device 20 that it is the return from the system hibernation.

As described above, the embodiment makes it possible not only to effectively use the limited resource similarly to the first embodiment, but also to return to the state before being stopped in the return, because the work environment of the original user is held before being stopped when reallocation is carried out.

### Third Embodiment

Next, a third embodiment applying the invention will be described. In the return after the reallocation process according to the second embodiment, the system hibernation process can be effectively used only in the case of retuning in the original managed device 20. However, this embodiment makes it possible to return in the work environment before being stopped, when returning in any of the managed devices 20.

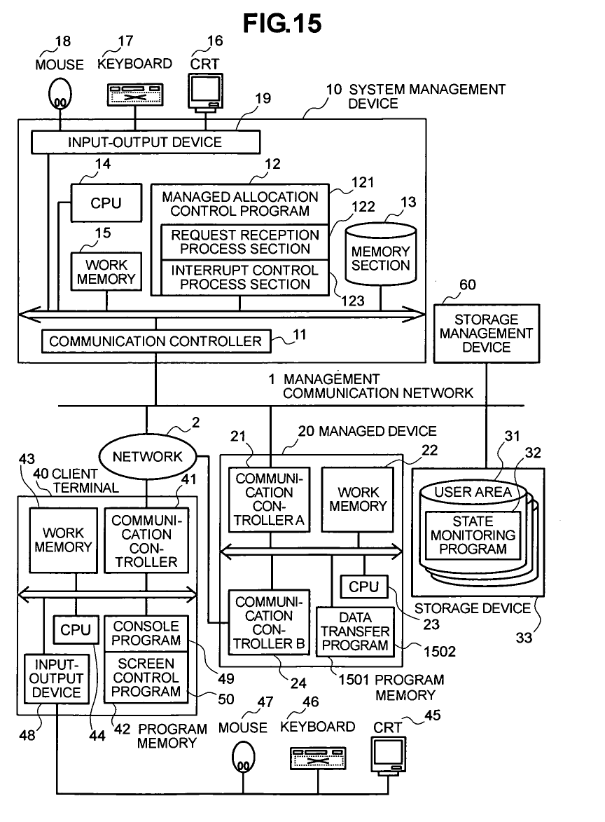

FIG. 15 is a system configuration view of the embodiment. The system configuration of the embodiment is essentially the same as the system configuration of the first embodiment. However, the managed devices 20 of the embodiment each include a program memory 1501 and a data transfer program 1502 within the program memory 1501.

The data transfer program 1502 is executed by the CPU 23 to realize an evacuated data transfer function for transferring the data to be evacuated when the system hibernation process is carried out in the relevant managed device 20, to the user area 31 that is allocated at this point.

The general operation of the embodiment is essentially the same as that of the first embodiment. However, the following parts in the reallocation process are different: the process of stopping the managed device to be stopped, and the registration process to the interrupt information table 1000, namely, the processes of Steps 711 and 714 of FIG. 11; and the return process of the stopped user in the stop process, namely, the process of Step 1203 of FIG. 12.

Hereinafter, only the different points of the embodiment from the first embodiment will be described. In the embodiment, when the specific managed device 20 is selected as the stop target, the interrupt control process section 123 refers to the internal table 800 to confirm the utilization of the relevant managed device 20 used by the allocated user.

At this time, when the session condition 803 is “unconnected” and the user process 806 is “0”, no work is done on the managed device 20, so that the interrupt control process section 123 just stops the managed device 20.

In other cases, the interrupt control process section 123 causes the managed device 20 to carry out the system hibernation, before stopping the managed device 20. At this time, the managed device 20 receives the instruction to carry out the system hibernation, and causes the evacuated data transfer function to transfer the data about the work environment (the contents in the work memory 22) at this point to the data area 31. The interrupt control process section 123 stops the relevant managed device 20 after the system hibernation is completed.

Incidentally, also in the embodiment, similarly to the second embodiment, the interrupt control process section 123 may be configured to cause the managed device 20 to always carry out the hibernation before stopping, after the managed device 20 to be stopped is identified, without the step of referring to the internal table 800 to confirm the state of the relevant managed device 20.

Further, in the registration process to the interrupt information table 1000 (Step 714) in the embodiment, similarly to the second embodiment, the interrupt control process section 123 registers as the hibernation 1401 whether the managed device carried out the system hibernation before stopping, in addition to the information that is registered in the first embodiment. The registered contents are the same as those of the second embodiment, so that the description is omitted herein.

Next, relating to the process of the request reception process section 122 upon reception of the release request, the difference between the first embodiment and this embodiment will be described.

The difference in the present embodiment is the process in the startup of the user identified as the return user. The process corresponds to Step 1203 of FIG. 12. In the embodiment, when the return user is identified, the request reception process section 122 refers to the interrupt information table 1000 to determine whether the user identified as the return user carried out the system hibernation before stopping. More specifically, the section determines whether the hibernation 1401 is “True”. If “True”, the section notifies the managed device 20 that the system hibernation process is done.

The managed device 20 receives the notification, and accepts the evacuated data transferred from the allocated data area 31 to start up in the original operation state of the user identified as the return user, by expanding the transferred data in the work memory 22. Also in the embodiment, the request reception process section 122 may be configured to inquire the user whether to start up in the original state in the return, thereby to start up depending on the response.

As described above, with the embodiment, the work environment of the original user is evacuated to the user area 31, which is allocated to each user and provided in the storage device 30 side, so that it is possible to return in the original work environment in the work environment not only of the user having used the relevant managed device 20 before being stopped, but of the user returning after being stopped. In other words, the stopped user can return in the state before being stopped, to any of the managed devices 20 if unoccupied.

Having described preferred embodiments of the invention with reference to the accompanying drawings, it is to be understood that the invention is not limited to the embodiments and that various changes and modifications could be effected therein by one skilled in the art without departing from the spirit or scope of the invention as defined in the appended claims.

What is claimed is:

1. A computer resource allocation system for allocating one of a plurality of computer resources to a user requesting the use, comprising:
an allocation section, when a user request comes from a new user, for allocating a computer resource not allocated to any user, to the user; and
an allocation release section, when a use request comes from a new user while all the computer resources are allocated, for defining said computer resource to be released from the allocation in accordance with the release condition determining the state that the user is not using, thereby to release the allocation, wherein
when the use request comes from the new user while all the computer resources are allocated, said allocation section allocates the computer resource that said allocation release section released, to said user requesting the use.

2. The computer resource allocation system according to claim 1, further comprising:
a user attribute holding section for holding the attributes of the users that can be allocated to said computer resource;
a computer resource attribute holding section for holding the attributes of the computer resources; and
a utilization monitoring section for monitoring the utilization state of said computer resource allocated by said allocation section, wherein
said release condition is written using said user attribute, said computer resource attribute, and said utilization state.

3. The computer resource allocation system according to claim 2, wherein
said release condition further comprises a start condition written about whether to inquire said user requesting the use before releasing the computer resource already allocated to another user, when all the computer resources are allocated.

4. The computer resource allocation system according to claim 2, wherein
said release condition further comprises a definition condition written about whether to inquire the computer resource defined as the candidate to be released from the allocation about the possibility of the release, when all the computer resources are allocated.

5. The computer resource allocation system according to claim 3, wherein
when said start condition is written about the inquiry, the system accepts the instruction of the usage time, in addition to the existence or non-existence of the use.

6. The computer resource allocation system according to claim 5, wherein
when all the computer resources are allocated, said release condition further comprises a definition condition written about whether to inquire the computer resource defined as the candidate to be released from the allocation, and
when said definition condition is written about the inquiry, presenting the usage time inquired in said start condition upon inquiry.

7. The computer resource allocation system according to any of claims 1 to 6, further comprising,
when said allocation section allocates the computer resource that said allocation release section released to said user requesting the use, an interrupt information management section for managing the relevant computer resource, the newly allocated user, and the user released from the allocation by associating with each other.

8. The computer resource allocation system according claim 7, wherein
when the user completes the use of the computer resource and when the user completing the use is registered in said interrupt information management section as the newly allocated user, said allocation section reallocates said computer resource whose use is completed, to the user that is released from the allocation and is registered being associated with the relevant user, and
when the user completes the use of the computer resource and the user who completing the use is not registered in said interrupt information control section as the newly allocated user, but if there are users registered in said interrupt information management section as the user released from the allocation, said allocation section reallocates said computer resource whose use is completed to one user of the relevant users.

9. The computer resource allocation system according claim 8, wherein
said allocation release section, when releasing the allocation of the defined computer resource, causes the computer resource, before release, to hold the operation state of the relevant computer resource at this point within the relevant computer resource, and
when the user completes the use of the computer resource and when the user completing the use is registered in said interrupt information management section as the newly allocated user, said allocation section reallocates said computer resource whose use is completed, to the user that is released from the allocation and is registered being associated with the relevant user, causing the computer resource to return the operation state of the relevant computer resource before release, which is held in said computer resource, upon startup.

10. The computer resource allocation system according claim 8, further comprising
a storage section for allocating the data area required for using the computer resource to each user and holding the allocated data area, wherein
said allocation release section, when releasing the allocation of the defined computer resource, causes the computer resource before release to hold the operation state of the relevant computer resource at this point, in the data area allocated to the user having used before release within said storage section,
when the user completes the use of the computer resource and when the user completing the use is registered in said interrupt information management section as the newly allocation user, said allocation section reallocates said computer resource whose use is completed to the user that is released from the allocation and is registered being associated with the relevant user, causing the computer resource to return the operation state of the relevant computer resource before release, which is held in the data area of the relevant user within said storage section, upon startup, and
when the user completes the use of the computer resource and when the user completing the use is not registered in said interrupt information management section as the newly allocated user, but if there are users registered in said interrupt information management section as the user released from the allocation, said allocation section reallocates said computer resource whose use is completed to one user of the relevant users, causing the computer resource to return the memory contents before release, which are held in the data area of the relevant user within said storage section, upon startup.

11. A computer resource allocation method of allocating one of a plurality of computer resources to a user requesting the use, comprising the steps of:
an allocation resource extraction step, when a user requests the use, for determining the existence or non-existence of the computer resource not allocated to any user; and
an allocation step, when it is defined as existing in said allocation resource extraction step, for allocating the computer resource not allocated to any user to the user requesting the use, and when it is defined as non-existing, the allocation step for defining the computer resource to be released from the allocation, in accordance with the release condition for determining the state that the user is not using, thereby to allocate the defined computer resource to said user requesting the use.
